(19) United States
(12) Patent Application Publication
(10) Pub. No.: US 2005/0146159 A1
(43) Pub. Date: Jul. 7, 2005

(54) Sliding door and safety device thereof

(76) Inventors: Der-Young Shen, Taoyuan Hsien (TW); Chung-Jung Yang, Taoyuan Hsien (TW); Wei-Chih Chi, Taoyuan Hsien (TW); Ming Yeh, Taoyuan Hsien (TW)

Correspondence Address: BIRCH STEWART KOLASCH & BIRCH, PO BOX 747, FALLS CHURCH, VA, 22040-0747, US

(21) Appl. No.: 10/900,361

(22) Filed: Jul. 28, 2004

(30) Foreign Application Priority Data
Jan. 5, 2004 (TW) 93100170

(51) Int. Cl. B60J 5/06

(52) U.S. Cl. 296/155

(57) ABSTRACT

A sliding door and a safety device thereof are described. The sliding door is opened and closed parallel to a body of a car to reduce efficiently the width requirement for opening a car door. The sliding door has a door body, a power transmission device, and a supporting device. The supporting device supports the sliding door and couples the power transmission device to the body of the car by way of only one end portion of the door body. The sliding door further has a handle and a safety device to enhance effectively driving safety.

### FIELD OF THE INVENTION

The present invention relates to a sliding door and safety device thereof, and more particularly, to a power sliding door and safety device thereof.

### BACKGROUND OF THE INVENTION

Over the past hundred years, the automobile industry has become highly developed and continuously progresses with manufacturing technology and material science developments. The high degree of development in the automobile industry not only promotes the automobile manufacturing technology but also improves industrial technology as a whole. However, a key point of automobile design and manufacturing is to provide a safe and comfortable driving environment for all drivers, whether of high price luxury sedans, minivans or economy cars. Therefore, the progression of the automobile not only depends on the technological improvement thereof but also the related industrial improvements.

Referring to FIG. 1A and 1B, a conventional four-door sedan 100 generally utilizes front doors 102 and rear doors 104, which are hinged and laterally opened. Besides, a minivan 120 of FIG. 1B generally utilizes front doors 122 and a rear sliding door 124. The hinged and laterally opened doors are used as the doors for both driver and front passenger seats. In a minivan or the like, the door can be designed as a sliding door because the rear cabin of the car has a regular shape with large volume and can be installed with two sliding rails at top and bottom of the cabin for stably opening and closing the sliding door.

Compared with the sliding door, the hinged doors require a wider clearance for opening the doors to get freely in or out the car. When the hinged doors are open, the hinged doors are still limited by safety and angle of opening limitations, so the hinged doors cannot be fully opened. Therefore, the passenger and the driver may suffer inconvenience when entering or exiting the car.

However, the sliding rear door 124 of the minivan 120 requires installation of two sliding rails on a regular car body to support the sliding rear door 124. Hence, the front and rear doors of four-door sedan 100 and the front doors of the minivan 120, with irregular shapes, are not suitable for installation of sliding doors.

Recently, due to population increases and industrial progression, the quantity of cars increases day by day, therefore the territorial utilization area for each human is diminished. The driver or the passenger, especially in the city, always feels the space between neighbor cars or walls is not adequate to open the hinged doors. Therefore, the driver and the passenger may suffer inconvenience when entering or exiting a car.

### SUMMARY OF THE INVENTION

One objective of the present invention is to provide a sliding door suitable for installation in the driver, passenger or even a rear door position of a car to allow a passenger or a driver to enter or exist the car more conveniently.

Another objective of the present invention is to provide a sliding door to reduce a parking space requirement for a car, and therefore utilization efficiency of the parking area can be increased.

A further objective of the present invention is to provide a safety device of a sliding door to enhance the safety performance of the sliding door and to further enhance the driving safety.

To accomplish above objectives, the present invention provides a sliding door for a car. The sliding door can be opened and closed parallel to a car body. The sliding door includes a door body, a power transmission device, and a supporting device. The sliding door further includes a door handle and safety device. The power transmission device is configured on the door body to provide a power for opening or closing the sliding door parallel to the car body. The supporting device configured at one end portion of the door body couples the power transmission device to the car body to support effectively the sliding door.

The power transmission device further includes a motor, a clutch assembly, a gear set, and a ball screw. The motor can rotate the clutch assembly to drive the gear set and rotate the ball screw so as to move the sliding door. The gear set includes a first bevel gear and a second bevel gear. The clutch assembly, e.g. a clutch or an actuator, can separate the second bevel gear from the motor.

The supporting device further includes a sliding rail, a slide, a first supporting arm, and a second supporting arm. The first supporting arm further includes a pinion for engaging with a rack on the door body to provide a rotational force to close tightly the sliding door on the car body when the sliding door is closed. The second supporting arm further comprises an elastic member to provide an auxiliary force for opening the sliding door.

The door handle further includes a switch to control the power transmission device to move the sliding door forward or backward, and an emergency stop device to stop the sliding door in an emergency.

The safety device further includes a safety switch, a hook, and a safety shaft. The safety shaft is inserted into a first rotational shaft and a second rotational shaft to couple the first rotational shaft and the second rotational shaft to the car body. In a dangerous situation, the safety switch can be rotated to pull out the safety shaft so as to separate the sliding door from the car body, and the user can escape from the car more conveniently.

The sliding door according to the present invention can be opened and closed parallel with the car body. Therefore, the widths for opening car doors can be reduced. The sliding door can apply to various shapes of car doors, for example a driver side and a passenger side door, because the supporting device is only configured at one end portion, for example the bottom portion, of the door body, and the car door thus is more aesthetically pleasing. The sliding door can operate with electrical power or human force and further use a safety device to fully protect the passenger in the car.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A is a schematic view of a conventional four-door sedan;

FIG. 1B is a schematic view of a conventional minivan;

FIG. 2A is a schematic view of a four-door sedan with sliding doors according to the present invention;

FIG. 2B is a schematic view of a minivan with sliding doors according to the present invention;

FIG. 3 is a schematic view of a preferred embodiment of the sliding door according to the present invention;

FIG. 4 is a schematic view of another preferred embodiment of the sliding door according to the present invention; and

FIG. 5 is a schematic view of a preferred embodiment of the power transmission device of the sliding door according to the present invention.

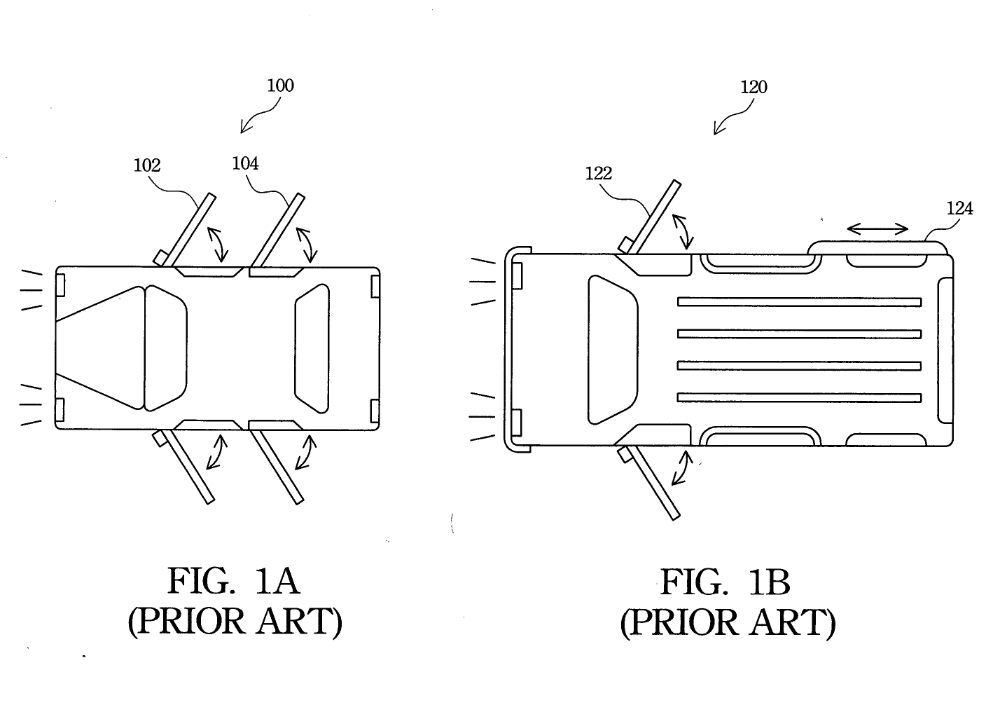

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

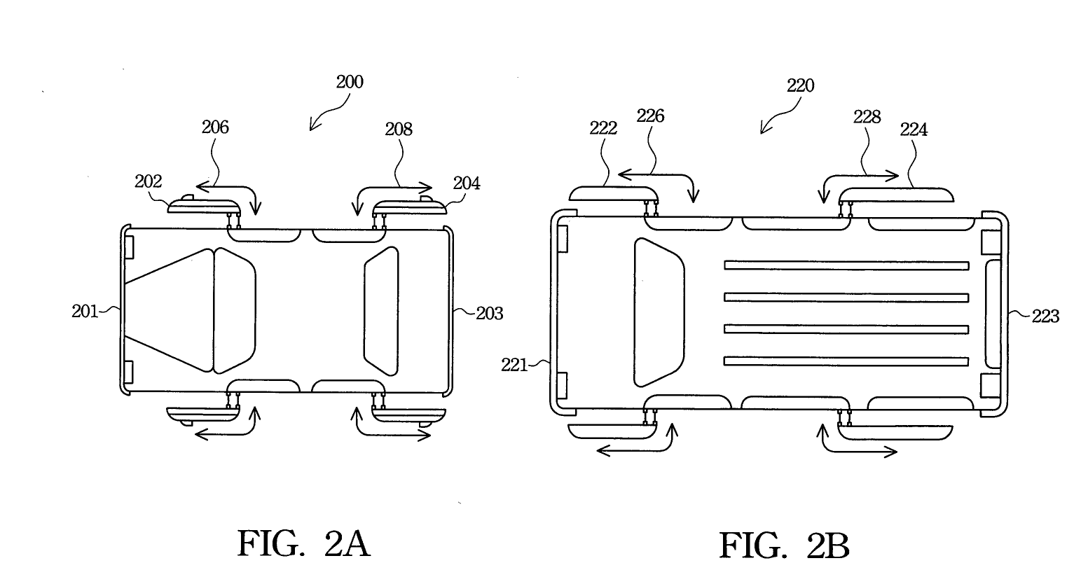

FIG. 2A is a schematic view of a four-door sedan with sliding doors according to the present invention and FIG. 2B is a schematic view of a minivan with sliding doors according to the present invention. The sedan 200 has a sliding front door 202 and a sliding rear door 204, and further has two similar doors on the other side. The left-front door is similar to the sliding rear door 204 and the left-rear door is similar to the sliding front door 202.

When a user wishes to open the sliding front door 202, the user just pushes the sliding front door 202 toward a front portion 201 of the car 200 and the sliding front door 202 thus is opened along a movement direction 206. When the user wishes to close the sliding front door 202, the user just pulls the sliding front door 202 toward a tail portion 203 of the car 200. Similarly, the user can easily open the sliding rear door 204 toward the tail portion 203 of the car 200 along the movement direction 208 and close the sliding rear door 204 in the opposite direction.

When the sliding front door 202 is opened, the sliding front door 202 can be completely pushed to the front portion 201 of the car 200, and accordingly, a passenger can conveniently enter or exit the car 200. In the same manner, the passenger seating in the rear seat of the car 200 can also very conveniently enter or exit through the sliding rear door 204. When the sliding front door 202 and the sliding rear door 204 are both opened, the sliding front door 202 is pushed to the front and the sliding rear door 204 is pushed to the rear. Accordingly, both the sliding front door 202 and the sliding rear door 204 can be opened simultaneously and the passengers seated in the front seats and the passengers seated the rear seats can enter or exit without any interference. Because the length of the front portion 201 is effectively used to absorb the width of the sliding front door 202, the sliding front door 202 can be completely opened. In addition to the width of the sliding rear door 204 can effectively hide in the length of the tail portion 203. Hence, the passengers can easily enter or exit the car 200.

Referring to FIG. 2B, the minivan 220 also has a sliding front door 222 and a sliding rear door 224. When a user wishes to open the sliding front door 222, the user just pushes the sliding front door 222 toward a front portion 221 of the car 220 and the sliding front door 222 can thus be opened along a movement direction 226. When the user wishes to close the sliding front door 222, the user just pulls the sliding front door 222 toward a tail portion 223 of the car 220. Similarly, the user can easily open the sliding rear door 224 toward the tail portion 223 of the car 220 along the movement direction 228 and close the sliding rear door 224 in the opposite direction.

The sliding door of the present invention can be opened and closed parallel to the body of the car. The space needed for opening the door is only a little bit wider than a thickness of the door. Therefore, a sedan, a minivan, or any other car with the sliding door according to the present invention can park in a narrow parking space. Because the space for opening the door is narrow, the protrusion distance, from the body of the car, of the opened door is limited so that a risk is reduced as the door is opening. Furthermore, the passengers can use the whole doorframe to enter or exit the car because the doors can be completely opened to the front or rear side. Consequently, the passengers can very easily enter or exit the car. In addition, the sliding doors according to the present invention can apply to a car without B-pillars so as to increase an interior space of the body of the car, improve the car's appearance, and broaden the views of the passengers.

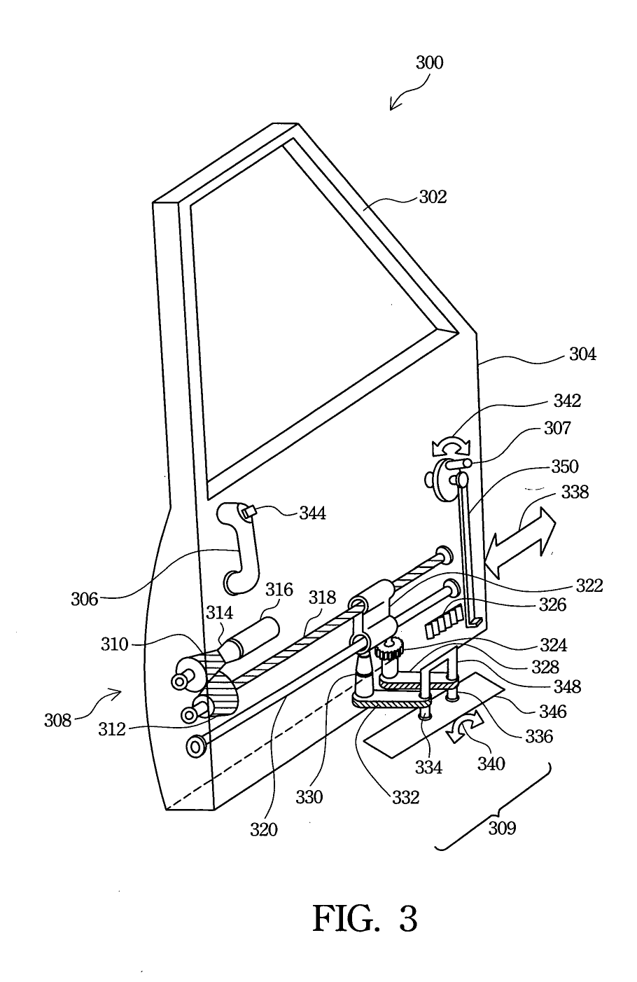

FIG. 3 is a schematic view of a preferred embodiment of the sliding door according to the present invention. The preferred embodiment is a sliding door for a left-front door or a right-rear door of a car. The sliding left-front door 300 has a door body 304, a window frame 302, a door handle 306, a power transmission device 308, and a supporting device 309. The window frame 302 is disposed at an upper portion of the door body 304; the door handle 306, the power transmission device 308, and the supporting device 309 are disposed below the window frame 302.

The door handle 306 further has a switch 344, preferably a power switch, to control the power transmission device 308 for opening or closing the door 300. The power transmission device 308 further has a motor 316, a clutch assembly 314, a first bevel gear 310, and a second bevel gear 312. The motor 316 is controlled by the switch 344 to provide power for opening or closing the door 300. When the motor 316 operates, the clutch assembly 314 rotates the first bevel gear 310. The second bevel gear 312 coupled with the first bevel gear 310 is then driven by the motor 316 to rotate a ball screw 318 of the supporting device 309 to open or close the door 300.

The clutch assembly 314 can further separate the second bevel gear 312 from the motor 316 to enable the front door 300 to be manually operated. The clutch assembly 314 can be a clutch for separating the motor 316 and the first bevel gear 310 to isolate rotations of the motor 316 and the second bevel gear 312. Alternatively, the clutch assembly 314 can be an actuator for separating the first bevel gear 310 from the second bevel gear 312 to isolate the rotations of the motor 316 and the second bevel gear 312.

When the rotations of the motor 316 and the second bevel gear 312 are isolated from each other, the second bevel gear 312 can freely rotate without constraint of the motor 316. Therefore, the user can manually operate the sliding left-front door 300.

The supporting device 309 supports the sliding left-front door 300, and especially when the sliding left-front door 300 is operating. The supporting device 309 has a ball screw 318, a sliding rail 320, a slide 322, a first supporting arm 328, a second supporting arm 332. Both ends of the ball screw 318 and the sliding rail 320 are coupled to the door body 304. One end of the first supporting arm 328 couples to a car body 346, and another end thereof couples to the slide 322. Moreover, one end of the second supporting arm 332 couples to the car body 346, and another end thereof couples to the slide 322. The slide 322 further glidingly couples to the ball screw 318 and the sliding rail 320. When the motor 316 rotates the second bevel gear 312, the ball screw 318 is forced to rotate and the slide 322 is forcibly moved along the ball screw 318 and the sliding rail 320, and therefore the front door 300 can move along the door movement direction 338 forward and backward.

The first supporting arm 328 further comprises a first rotational shaft 336 and a pinion 324. The first supporting arm 328 can rotate on the car body 346 via the first rotational shaft 336. The pinion 324 couples to a rack 326 to provide a rotational force for the front door 300 when the front door 300 is nearly closed, so as to rotate the front door 300 along a rotational direction 340 to close effectively the front door 300.

The second supporting arm 332 further has a second rotational shaft 334 and an elastic member 330. The second supporting arm 332 can rotate on the car body 346 via the second rotational shaft 334. The elastic member 330 provides an elastic force to assist pushing the front door 300 out of the car body 346 when the front door 300 is opened so as to reduce a force requirement for opening the front door 300. The first supporting arm 328 and the second supporting arm 332 are configured at the same end portion of the door body 304 to couple the sliding left-front door 300 to car body 346. Therefore, the supporting device 309 can be utilized in any sliding door, even on of irregular shape, so that the application scope of the sliding door can be effectively extended.

The front door 300 further has a safety device including a safety switch 307, a hook 350, and a safety shaft 348. The safety shaft 348 is inserted in the first rotational shaft 336 and the second rotational shaft 334 to couple effectively the first rotational shaft 336 and the second rotational shaft 334 on car body 346. The safety switch 307 is disposed on the door body 304 and is operated by way of rotation or movement. For example, the safety switch 307 is rotated along a rotational direction 342 to drive the hook 350, and the hook 350 releases the safety shaft 348 from the first rotational shaft 336 and the second rotational shaft 334. Accordingly, the first rotational shaft 336 and the second rotational shaft 334 are separated from the car body 346 so that the front door 300 can be easily opened. Hence, the user can easily release the door from the body of the car when the car is in danger. Therefore, the sliding door and safety device thereof can efficaciously improve the driving safety. The door handle 306 further provides an emergency stop function, for enhancing the operation safety of the sliding door, to stop moving the sliding door by way of rotating or pulling up the handle 306 in an emergency.

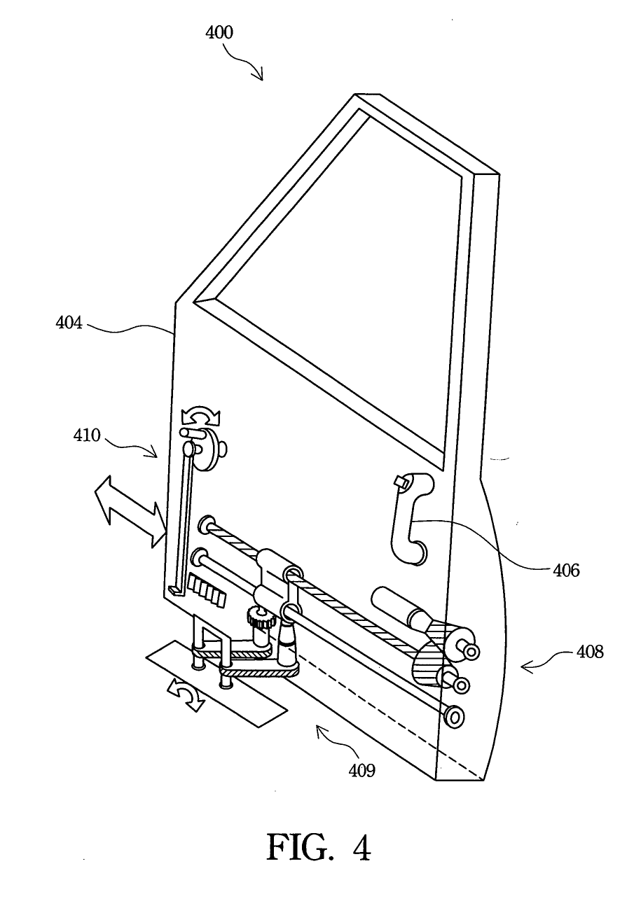

FIG. 4 is a schematic view of another preferred embodiment of the sliding door according to the present invention. The sliding right-front door 400 applies to a right front door of the car. In this matter, a similar structure can apply to the left rear door. The sliding right-front door 400 includes a door body 404, a door handle 406, a power transmission device 408, a supporting device 409, and a safety device 410. The components of the sliding right-front door 400 are similar and symmetrical to that of the sliding left-front door 300 of FIG. 3. Therefore, the sliding right-front door 400 can open and close along the direction of the car body. The functions of these components are also similar to that of the sliding left-front door 300 of FIG. 3.

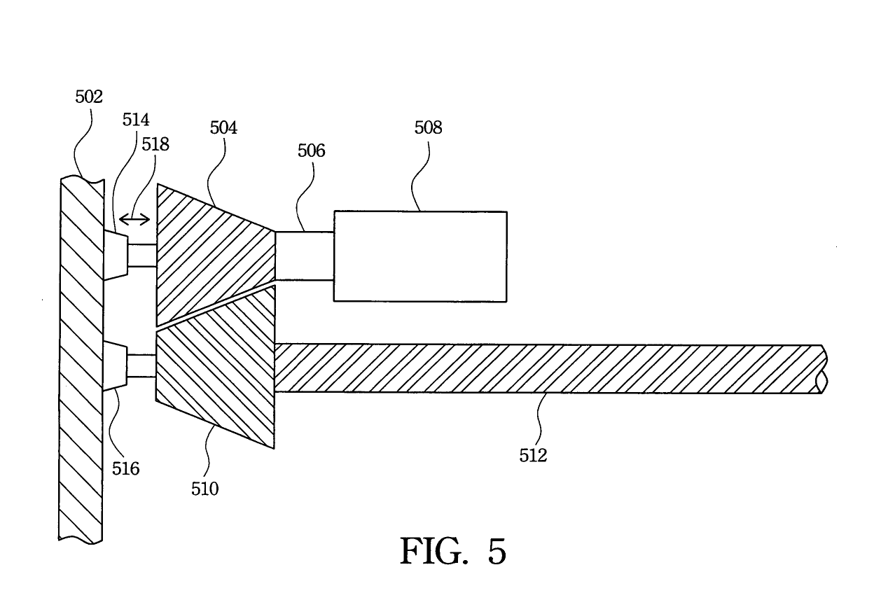

FIG. 5 is a schematic view of a preferred embodiment of the power transmission device of the sliding door according to the present invention. The power transmission device includes a motor 508, an actuator 506, a first bevel gear 504, and a second bevel gear 510. The first shaft coupling device 514 couples the first bevel gear 504 to the door body 502. The second shaft coupling device 516 couples the second bevel gear 510 to the door body 502. The first shaft coupling device 514 cooperates with the actuator 506 to move the first bevel gear 504 along a movement direction 518. When the actuator 506 pushes the first bevel gear 504 toward the door body 502 of FIG. 5, the first bevel gear 504 disengages from the second bevel gear 510 so that the first bevel gear 504 and the second bevel gear 510 rotate independently. When the actuator 506 pushes the first bevel gear 504 away from the door body 502 of FIG. 5, the first bevel gear 504 engages with the second bevel gear 510 so that the second bevel gear 510 driven by the motor 508 can rotate the ball screw 512 coupled with the second bevel gear 510 to move the sliding door.

The sliding door according to the present invention utilizes the supporting device to enable the car door to move parallel to the car body. Therefore, the widths for opening car doors can be reduced so as to reduce the parking space requirement for one car and further increase the driving safety. The sliding door can be opened completely so that the user conveniently enters and exits the car. Additionally, the user can more easily open and close the sliding door of the present invention with auxiliary components, for example, the elastic member, the rack and the pinion. The safety device can further provide a safer driving environment. Furthermore, the sliding door according to the present invention can apply to various shapes of car doors because the supporting device is only configured at one end portion, for example the bottom portion, of the door body. The interior structure of the sliding door can be covered by the trim panel of the car door, and therefore most of the supporting device can be hidden therein.

The sliding door according to the present invention is opened not only forward or backward along the car body but also upward or downward along the car body. As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A sliding door for use in a car body, comprising:
a door body;
a power transmission device coupling to the door body to provide power for opening or closing the sliding door parallel to the car body; and
a supporting device coupling the power transmission device to the car body, the supporting device configured at one end portion of the door body to support the sliding door.

2. The sliding door of claim 1, wherein the power transmission device further comprises:
a motor;
a clutch assembly;
a gear set; and
a guiding rod, wherein the motor rotates the clutch assembly to drive the gear set and the guiding rod so as to move the sliding door.

3. The sliding door of claim 2, wherein the gear set comprises:
a first gear coupling to the clutch assembly; and
a second gear coupling to the guiding rod to drive the guiding rod.

4. The sliding door of claim 3, wherein the clutch assembly comprises a clutch to disengage the first gear from the motor.

5. The sliding door of claim 3, wherein the clutch assembly comprises an actuator to disengage the first gear from the second gear.

6. The sliding door of claim 3, wherein the first and the second gears are bevel gears.

7. The sliding door of claim 2, wherein the supporting device further comprises:
a sliding rail installed on the door body;
a slide coupling to the sliding rail and the guiding rod, wherein the slide relatively moves along the sliding rail and the guiding rod so as to move the sliding door when the guiding rod is rotating;
a first supporting arm coupling the slide to the car body to support the sliding door; and
a second supporting arm coupling the slide to the car body to support the sliding door, wherein the first supporting arm and the second supporting arm are configured at one end portion of the door body.

8. The sliding door of claim 7, wherein the first supporting arm further comprises a pinion for engaging with a rack on the door body to provide a rotational force to close the sliding door tightly on the car body when the sliding door is closed.

9. The sliding door of claim 7, wherein the second supporting arm further comprises an elastic member to provide an auxiliary force for opening the sliding door.

10. The sliding door of claim 1, wherein the sliding door further comprises a door handle with a switch to control the power transmission device to move the sliding door forward or backward.

11. The sliding door of claim 10, wherein the door handle further comprises an emergency stop device to stop the sliding door.

12. A sliding door for use in a car body, comprising:
a door body;
a power transmission device coupling to the door body to provide power for opening or closing the sliding door parallel to the car body; and
a supporting device coupling the power transmission device to the car body, the supporting device configuring at one end portion of the door body to support the sliding door;
a safety device, the safety device further comprising:
a switch mechanism coupling to the door body;
an engaging member coupling to the switch mechanism; and
a shaft coupled to the car body;
wherein when the sliding door needs to be separated from the car body, the switch mechanism is rotated to drive the engaging member to pull out the shaft from the car body.

13. The sliding door of claim 12, further comprising a door handle installed on the door body.

14. The sliding door of claim 13, wherein the door handle comprises:
a button for controlling the power transmission device to move the sliding door forward and backward; and
an emergency stop device for stopping the sliding door in an emergency.

15. The sliding door of claim 12, wherein the power transmission device further comprises:
a motor;
a clutch assembly;
a gear set; and
a guiding rod, wherein the motor rotates the clutch assembly to drive the gear set and the guiding rod so as to move the sliding door.

16. The sliding door of claim 15, wherein the gear set comprises:
a first gear coupling to the clutch assembly; and
a second gear coupling to the guiding to drive the guiding rod.

17. The sliding door of claim 16, wherein the clutch assembly comprises a clutch to disengage the first gear from the motor.

18. The sliding door of claim 16, wherein the clutch assembly comprises an actuator to disengage the first gear from the second gear.

19. The sliding door of claim 16, wherein the first and the second gears are bevel gears.

20. The sliding door of claim 15, wherein the supporting device further comprises:
a sliding rail installed on the door body;
a slide coupling to the sliding rail and the guiding rod, wherein the slide relatively moves along the sliding rail and the guiding rod so as to move the sliding door when the guiding rod is rotating;
a first supporting arm coupling the slide to the car body to support the sliding door; and
a second supporting arm coupling the slide to the car body to support the sliding door, wherein the first supporting arm and the second supporting arm are configured at one end portion of the door body.

21. The sliding door of claim 20, wherein the first supporting arm further comprises a pinion for engaging with a rack on the door body to provide a rotational force to close the sliding door tightly on the car body when the sliding door is closed.

22. The sliding door of claim 20, wherein the second supporting arm further comprises an elastic member to provide an auxiliary force for opening the sliding door.
